(19) United States
(12) Patent Application Publication
(10) Pub. No.: US 2010/0330960 A1
(43) Pub. Date: Dec. 30, 2010

(54) SYSTEMS, METHODS, AND COMPUTER READABLE MEDIA FOR THIRD PARTY MONITORING AND CONTROL OF CALLS

(76) Inventors: Venkataramaiah Ravishankar, Cary, NC (US); Apirux Bantukul, Cary, NC (US); Peter J. Marsico, Chapel Hill, NC (US)

Correspondence Address: JENKINS, WILSON, TAYLOR & HUNT, P. A., 3100 Tower Blvd., Suite 1200, DURHAM, NC, 27707, US

(21) Appl. No.: 12/823,837

(22) Filed: Jun. 25, 2010

Related U.S. Application Data
(60) Provisional application No. 61/220,560, filed on Jun. 25, 2009.

(51) Int. Cl. H04W 12/00; H04M 3/22; G06F 17/30

(52) U.S. Cl. 455/410; 379/32.01; 707/769; 707/E17.014

(57) ABSTRACT

Methods, systems, and computer readable media for third party monitoring and control of calls are disclosed. For example, a method performed at a signaling node includes receiving a signaling message indicating an attempted call communication to a called party device from a calling party device and determining if the called party device is subscribed to a call monitoring service. In response to determining that the called party device is subscribed to the call monitoring service, sending a notification message to a monitoring third party device associated with the called party device, wherein the notification message indicates the attempted call communication between the monitored called party device and the calling party device. The method further includes receiving a response to the notification message from the third party device, and determining whether or not to allow the attempted communication to proceed between the monitored called party device and calling party device based on the response from the monitoring third party device.

### PRIORITY CLAIM

This application claims the benefit of U.S. Provisional Patent Application Ser. No. 61/220,560, filed Jun. 25, 2009; the disclosure of which is incorporated herein by reference in its entirety.

### TECHNICAL FIELD

The subject matter described herein relates to providing control of a subscriber's connections in a telecommunications environment to an associated monitoring party. More particularly, the subject matter described herein relates to systems, methods, and computer readable media for third party monitoring and control of calls.

### BACKGROUND

Traditional telecommunications networks allow users to initiate and receive telephone calls and messages at will. Situations arise where users may desire to monitor calls and messages originating from or terminating to another user. The monitoring user may further wish to obtain certain information about the non-monitored party, such as a directory number, a name, and any other pertinent information pertaining to the non-monitored party. Further, upon receiving information regarding the non-monitored party, the monitoring user may wish to prevent certain calls originating from or terminating to the monitored user. For example, a parent may desire to monitor and control calls originating from or terminating to a child's mobile phone. Notably, traditional wireless telecommunications networks do not have systems or methods available to users to monitor or control calls originating from or terminating to a supervised user.

Accordingly, there exists a need for systems, methods, and computer readable media for third party monitoring and control of calls.

### SUMMARY

Methods, systems, and computer readable media for third party monitoring and control of calls are disclosed. For example, a method performed at a signaling node includes receiving a signaling message indicating an attempted call communication to a called party device from a calling party device and determining if the called party device is subscribed to a call monitoring service. In response to determining that the called party device is subscribed to the call monitoring service, sending a notification message to a monitoring third party device associated with the called party device, wherein the notification message indicates the attempted call communication between the monitored called party device and the calling party device. The method further includes receiving a response to the notification message from the third party device, and determining whether or not to allow the attempted communication to proceed between the monitored called party device and calling party device based on the response from the monitoring third party device.

The subject matter described herein for third party monitoring and control of calls may be implemented in hardware, software, firmware, or any combination thereof. As such, the terms “function”, “application,” or “module” as used herein refer to hardware, software, and/or firmware for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary embodiment of a network implementing third party monitoring and control of calls;

FIG. 2 is a call flow diagram illustrating an exemplary call flow for a triggerless ISUP-intercept based parental control implementation of the present subject matter wherein the call originates from an SS7 network, the called party is the monitored child, and the call is allowed;

FIG. 3 is a call flow diagram illustrating an exemplary call flow for a triggerless SRI-intercept based parental control implementation of the present subject matter wherein the called party is the monitored child and the call is allowed;

FIG. 4 is a call flow diagram illustrating an exemplary call flow for a triggerless SRI-intercept based parental control implementation of the present subject matter wherein the called party is the monitored child and the call is rejected;

FIG. 5 is a call flow diagram illustrating an exemplary call flow for an IN/AIN trigger-based parental control implementation of the present subject matter wherein the called party is the monitored child and the call is allowed;

FIG. 6 is a call flow diagram illustrating an exemplary call flow for an IN/AIN trigger-based parental control implementation of the present subject matter wherein the called party is the monitored child and the call is rejected;

FIG. 7 is a block diagram illustrating an exemplary embodiment of a network implementing systems, methods, and computer readable media for third party monitoring and control of calls;

FIG. 8 is a call flow diagram illustrating an exemplary call flow for a SIP trigger-based parental control implementation of the present subject matter wherein the called party is the monitored child and the call is allowed;

FIG. 9 is a call flow diagram illustrating an exemplary call flow for a SIP trigger-based parental control implementation of the present subject matter wherein the called party is the monitored child and the call is rejected;

FIG. 10 is a call flow diagram illustrating an exemplary call flow for an IN/AIN trigger-based parental control implementation of the present subject matter wherein the called party is the monitored child, the call is rejected, the call is redirected to the monitoring party, and the third party is added to a blacklist

FIG. 11 is a call flow diagram illustrating an exemplary call flow for a triggerless ISUP-intercept based parental control implementation of the present subject matter wherein the call originates from an SS7 network, the calling party is the monitored child, and the call is allowed;

FIG. 12 is a call flow diagram illustrating an exemplary call flow for a triggerless ISUP-intercept based parental control implementation of the present subject matter, wherein the call originates from an SS7 network, the calling party is the monitored child, and the call is allowed;

FIG. 13 is a call flow diagram illustrating an exemplary call flow for an IN/AIN trigger-based parental control implementation of the present subject matter wherein the calling party is the monitored child and the call is allowed;

FIG. 14 is a call flow diagram illustrating an exemplary call flow for a SIP trigger-based parental control implementation of the present subject matter wherein the calling party is the monitored child and the call is allowed;

FIG. 15 is a call flow diagram illustrating an exemplary call flow for a SMS trigger-based parental control implementation of the present subject matter wherein the receiving party is the monitored child and the SMS is allowed;

FIG. 16 is a call flow diagram illustrating an exemplary call flow for a SRI short message based parental control implementation of the present subject matter, wherein the receiving party is the monitored child and the message is allowed; and

FIG. 17 is a call flow diagram illustrating an exemplary call flow for a SIP trigger-based parental control implementation of the present subject matter wherein the called party is the monitored child and the call is rejected.

### DETAILED DESCRIPTION

Reference will now be made in detail to exemplary embodiments of the present subject matter, examples of which are illustrated in the accompanying drawings. Wherever possible, the same reference numbers will be used throughout the drawings to refer to the same or like parts.

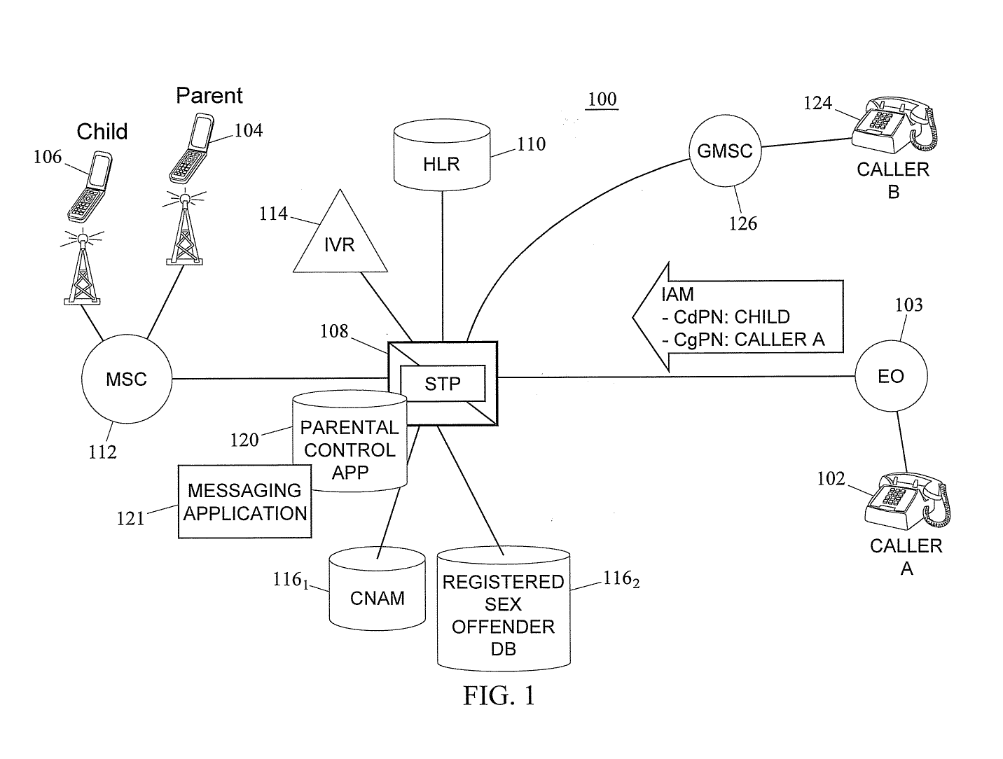

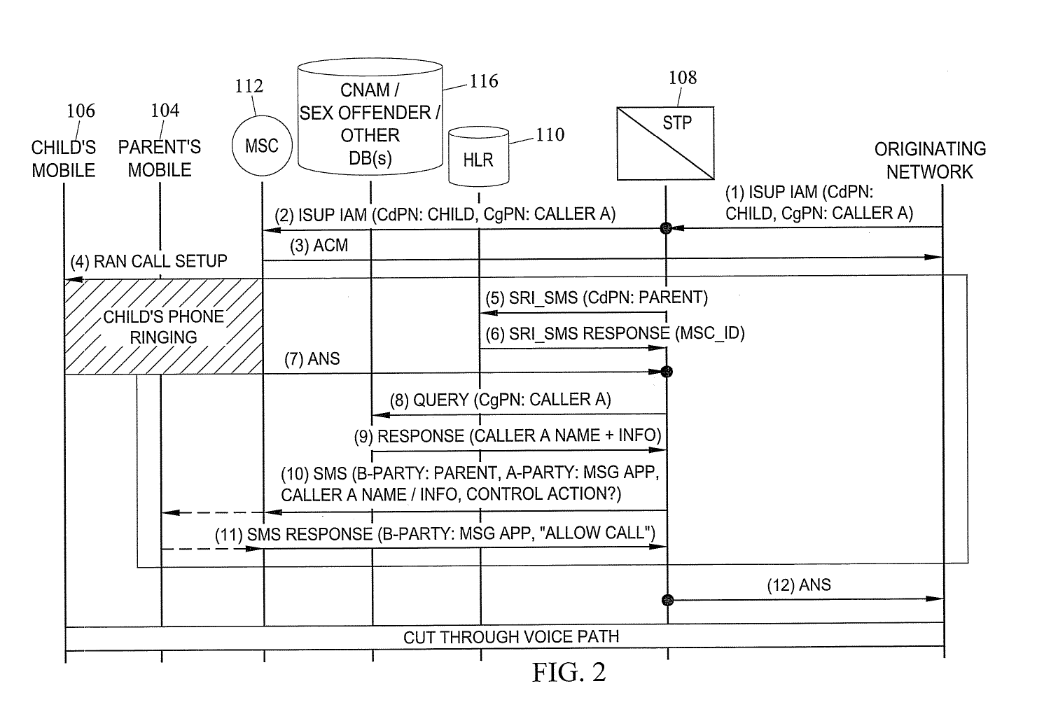

FIG. 1 is a block diagram illustrating an exemplary embodiment of a network 100 implementing third party monitoring and control of calls. This embodiment illustrates an Integrated Services Digital Network (ISDN) User Part (ISUP) Initial Address Message (IAM) intercept-based parental control implementation. Network 100 may include a caller A telephony device 102, connected to the network via an end office 103, and a caller B telephony device 124, connected to network 100 via a Gateway Mobile Switching Center (GMSC) 126. Network 100 may further include a monitored party and a monitoring party. In FIG. 1, a child's mobile device 106 is subscribed to a monitoring and control service, with parent's mobile device 104 being the monitoring device. Each of parent mobile device 104 and child mobile device 106 may be connected to the network via a Mobile Switching Center (MSC) 112. Network 100 may further include a Signal Transfer Point (STP) 108 including a parental control application or module 120, which may include a messaging application or module 121 and a subscriber database (not shown). Notably, STP 108 may include a processing unit to operate the applications/modules. In other embodiments, messaging application 121 may be configured to send and receive short message service (SMS) messages, instant messages, email messages, multimedia message service (MMS) messages, and other message types. Messaging application 121 may process the SMS, email, and instant messages received by parental control application 120. Similarly, messaging application 121 may generate SMS, email, and instant messages that are sent by parental control application 120 to nodes and telephony devices in network 100. Parental control application 120 may perform parental control related processing and signaling. Exemplary parental control processing and signaling may include: determining whether a called or calling party is a subscriber to monitoring service based on number or address data contained in received signaling messages; querying databases 116 to obtain information associated with a non-monitored party; generating messages (for example, SMS messages, instant messages, and email messages) containing information about the non-monitored (for example, caller A's telephony device 102) and monitored (for example, child's mobile device 106) party; sending SMS messages using the messaging application to the monitoring (for example, parent's mobile device 104) party; receiving response messages using the messaging application, and processing the call handling instructions (for example, allow call, block call, reject call, and forward call to IVR) contained in the response messages, and directing STP 108 on how to proceed with the call. In other embodiments, STP 108 may be connected to two databases: a CNAM database 116₁ and a registered sex offender database 116₂. Although only two databases are depicted in FIG. 2, additional databases may be utilized without departing from the scope of the present subject matter. In other embodiments, STP 108 may also be connected to a home location register (HLR) 110 and an Interactive Voice Response (IVR) server 114.

In one embodiment, STP 108 is configured to intercept an ISUP IAM associated with a call initiated by a calling party (for example, caller A's telephony device 102) to a mobile device associated with a child of a parent/guardian that is subscribed to the monitoring and control service. Parental control application 120 may then be provided with the calling party and called party number information by STP 108. Parental control application 120 may then determine that the call is destined for the child, and determine whether the child is subscribed to the parental control service. Parental control application 120 determines whether a party is subscribed to monitoring service by examining information associated with the calling party and the called party of a received signaling message. Parental control application 120 may also be provisioned to query databases, such as CNAM database 116₁ or Registered Sex Offender database 116₂ to gather information about the calling party (for example, caller A's telephony device 102). In other embodiments, parental control application 120 may be further configured to generate a message service message to parent's mobile device 104. The message service message may include information about the calling party and the called party, including directory number, name associated with the directory number, whether the party is a registered sex offender, or any other like information. Parental control application 120 may also be provisioned to receive and interpret a response to the message service message from the monitoring device. Parental control application 120 may further be configured to allow or reject the call between the called party and the calling party based on the monitoring party's response.

In one embodiment, the monitoring party may send and receive messages from messaging application 121 in parental control application 120. For example, the monitoring party may send and receive these messages on a mobile device, computer, PDA, or any other device capable of sending or receiving messages.

FIG. 2 is a diagram illustrating an exemplary call flow for a triggerless ISUP-intercept based parental control implementation of the present subject matter wherein the call originates from an SS7 network, the called party is the monitored child, and the call is allowed. Parent's mobile device 104 is the monitoring device in this embodiment. Message 1 represents a call signaling origination message, particularly an ISUP IAM. ISUP IAM includes the called party number (CdPN) of child's mobile device 106 and the calling party number (CgPN) of caller A's telephony device 102, as well as other information. In other embodiments, the telephony device 102 may include a mobile device, a PSTN telephone, and the like. When the call is originated, ISUP IAM is sent from the originating network (where caller A's telephony device 102 is located) to STP 108. STP 108 then forwards the ISUP IAM to MSC 112, which is communicatively connected to child's mobile phone 106.

MSC 112 sends an address complete message (ACM) to caller A's telephony device 102 on the originating network. MSC also sends a Radio Access Network (RAN) call setup message to the child's mobile device 106 which causes the child's mobile device 106 to ring. When STP 108 initially receives ISUP IAM, parental control application 120 determines whether the parent has subscribed to the parental control service. If the parent has subscribed to the service, STP 108 queries HLR 110 to determine the location of parent's mobile device 104 with a Send Routing Information for Short Message Service (SRI_SMS) message. HLR 110 replies to the query with an SRI_SMS response containing the ID of MSC 112 to which the parent's mobile device 104 is communicatively connected.

Message 7 is an answer message generated when the child answers mobile device 106, and is sent from MSC 112 to STP 108. STP 108 buffers this answer message until it receives control information from parental control application 120. Message 8 represents STP 108 querying a database 116, which may include a CNAM database, sex offender database, or any other database, using caller A's telephony device 102 CdPN information to lookup information associated with caller A's telephony device 102. Database 116 replies to the query with information relating to caller A's telephony device 102 (if available) and sends the information back to STP 108 in message 9. Message 10 represents an SMS sent from messaging application 121 on STP 108 to parent's mobile device 104 containing information relating to the calling party (for example, information received in message 9), the called party, and optional control actions, among others. This SMS may have been generated in parental control application 120 and sent to messaging application 121 for forwarding. For example, parent's mobile device 104 sends a reply text message back to messaging application on STP 108 stating that the call should be allowed. Messaging application 121 may process the reply SMS and forward the instruction information to parental control application 120. Parental control application 120 may instruct STP 108 to perform an action based on the instruction information in the response SMS. Upon receipt of an allowance message, STP 108 forwards the answer message to caller A's telephony device 102 to complete call setup and establish a voice path.

In one embodiment, the call may be rejected instead of allowed. For example, parent's mobile device 104 sends a reply text message back to messaging application on STP 108 stating that the call should be rejected. Messaging application 121 may process the reply SMS and forward the instruction information to parental control application 120. Parental control application 120 may instruct STP 108 to perform an action based on the instruction information in the response SMS. Upon receipt of an allowance message, STP 108 issues a release message to caller A's telephony device to terminate the call.

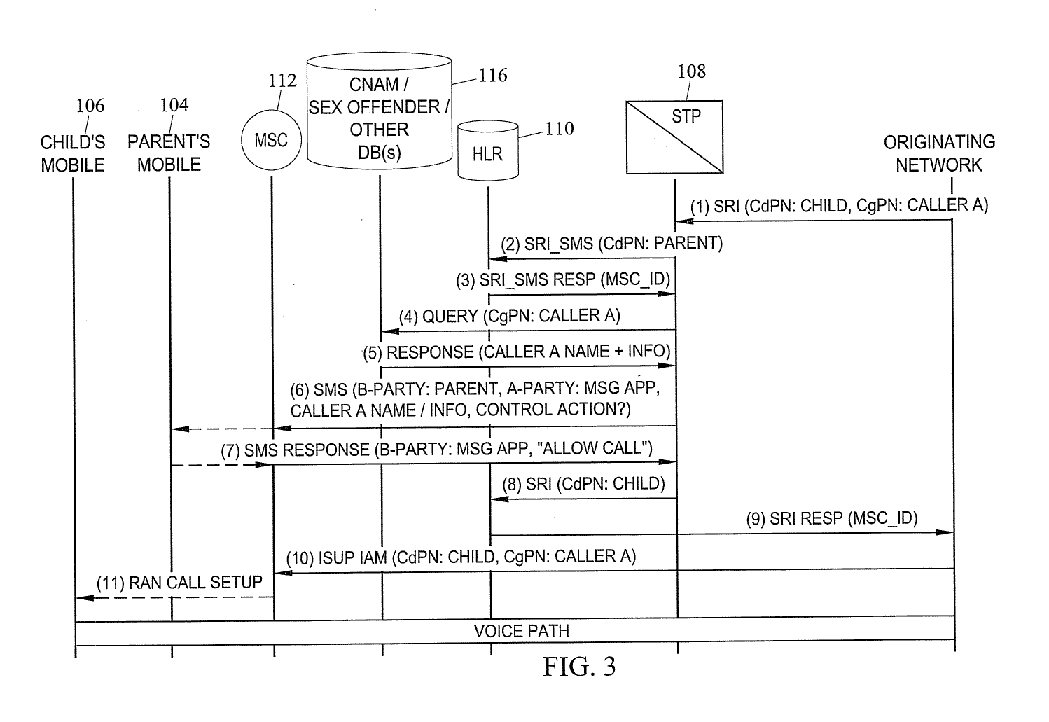

FIG. 3 is a diagram illustrating an exemplary call flow for a triggerless SRI-intercept based parental control implementation of the present subject matter wherein the called party is the monitored child and the call is allowed. Parent's mobile device 104 is the monitoring device in this embodiment. Message 1 represents a Send Routing Information (SRI) query message originating from caller A's telephony device sent via GMSC 126 and forwarded to STP 108. The SRI message contains the CdPN of child's mobile device 106 and CgPN of caller A's telephony device 102. STP 108 receives SRI message and parental control application 120 determines that the CdPN is subscribed to the call monitoring service. STP 108 may then buffer the SRI query and send a Send Routing Information for Short Message (SRI_SMS) query to HLR 110. SRI_SMS contains the CdPN of the parent's mobile device 104. HLR 110 responds with an SRI_SMS response containing the MSC ID of MSC 112 to which the parent's mobile device 104 is connected. Message 4 is a query sent from STP 108 to database 116, which may include a CNAM or sex offender database, among others. The query message contains the CgPN of caller A's telephony device 102. Database 116 replies to the query message with a response that contains information relating to caller A's telephony device 102. Messaging application 121 on STP 108 then sends a SMS message to the monitoring party's (parent's) mobile device 104. This SMS message contains information relating to caller A's telephony device 102 and the child's mobile device 106. Information may include, but is not limited to, information (for example, sex offender status) received from the database in message 5. Message 7 represents a reply from parent's mobile device 104 that includes an instruction to allow the call to proceed. Upon receipt of the “allow call” message, normal call setup process is resumed. STP 108 sends the buffered SRI to HLR 110, the SRI containing the CdPN of the child's mobile device 106. Message 9 represents a SRI response from HLR 110 containing the MSC ID of MSC 112 to which the child's mobile device 106 is communicatively connected, and message 10 is an ISUP IAM from caller A's telephony device 102 to MSC 112. Message 11 represents a RAN call setup message from MSC 112 to child's mobile device 106, which then enables a voice path to be opened.

In one embodiment, the call may be rejected instead of allowed. For example, parent's mobile device 104 sends an SMS response message back to messaging application on STP 108 stating that the call should be rejected. Messaging application 121 may process the reply SMS and forward the instruction information to parental control application 120. Parental control application 120 may instruct STP 108 to perform an action based on the instruction information in the response SMS. Upon receipt of an allowance message, STP 108 issues an SRI response to caller A's telephony device to bar the call.

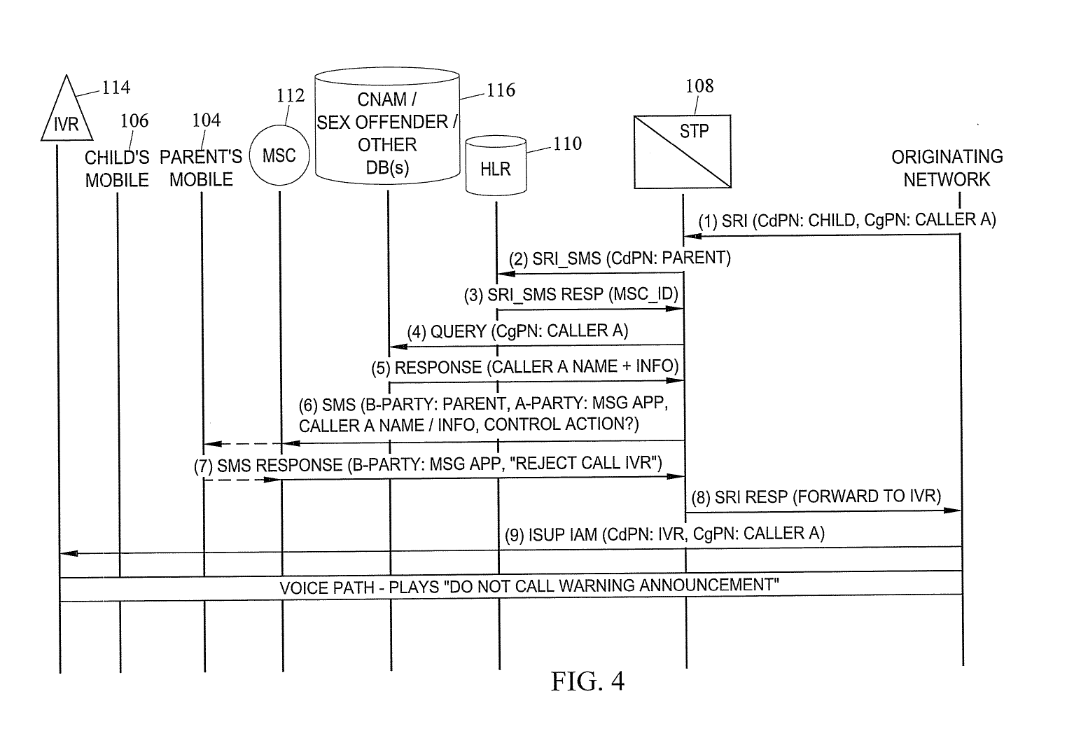

FIG. 4 is a diagram illustrating an exemplary call flow for a triggerless SRI-intercept based parental control implementation of the present subject matter wherein the called party is the monitored child and the call is rejected. Parent's mobile device 104 is the monitoring device in this embodiment. Message 1 is a SRI message originating from caller A's telephony device sent via GMSC 126 that requests initiating a SIP call with child's mobile device 106. In this embodiment, child's mobile device 106 is subscribed to monitoring service. After receiving the SRI query, STP 108, upon determination that the child's mobile device associated with the CdPN of the SRI is subscribed to monitoring, sends an SRI_SMS to HLR 110 with information about parent's mobile device 104 in the CdPN field. HLR 110 sends a SRI_SMS reply containing the MSC ID of MSC 116, to which parent's mobile device is connected. STP 108 may send a query message to database 116 in order to retrieve information relating to caller A's telephony device 102. The database 116 may reply to STP 108 with information associated with caller A's telephony device 102 in a response message. Message 6 represents a SMS message from messaging application on STP 108 to monitoring parent's mobile device 104 containing information associated with caller A's telephony device 102 and child's mobile device 106. In one embodiment, parent's mobile device 104 replies to the SMS message with an SMS response containing an instruction to reject the call, along with other instruction. For example, message 7 may additionally contain an instruction to forward the call to IVR 114. Message 8 represents an SRI response message from STP 108 to the originating network communicatively connected to caller A's telephony device 102, the SRI response message containing instruction to forward the call to IVR 114. Originating network then sends an ISUP IAM to IVR 114 in order to establish a voice path between caller A's telephony device 102 and IVR 114. In one embodiment, IVR 114 may play a pre-recorded warning message to caller A's telephony device 102. In another embodiment, instead of creating a voice path between the calling party and IVR 114, a voice path between the calling party and the parent mobile device 104 may be established.

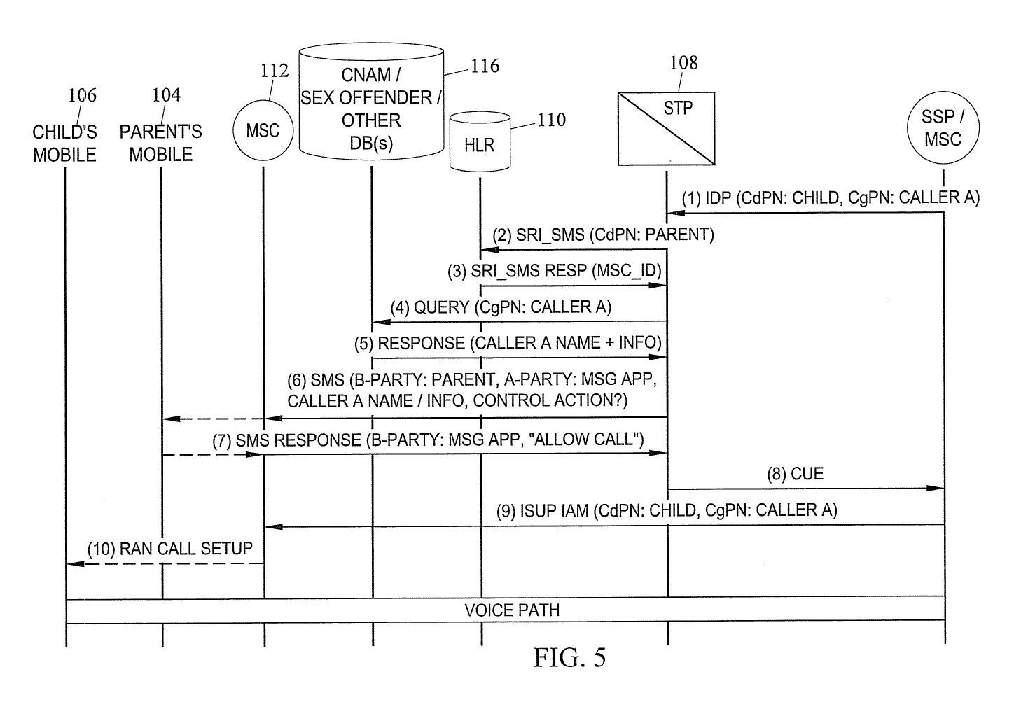

FIG. 5 is a diagram illustrating an exemplary call flow for an intelligent network (IN)/advanced intelligent network (AIN) trigger-based parental control implementation of the present subject matter wherein the called party is the monitored child and the call is allowed. Parent's mobile device 104 is the monitoring device in this embodiment. Message 1 is an initial detection point (IDP) message which may contain the CdPN of a monitored child's mobile device 106 and CgPN of caller A's telephony device 102. The IDP message is sent from a service switching point (SSP) or MSC to STP 108. Upon receipt of the IDP message via GMSC 126, parental control application 120 determines, based on the CdPN of the IDP message, that the called party (child's mobile device 106) is subscribed to a monitoring service. STP 108 then sends an SRI_SMS query message to HLR 110 in order to determine routing data to send an SMS message to parent's mobile device 104. HLR 110 sends an SRI_SMS response to STP 108, containing the MSC ID of MSC 112 to which parent's mobile device 104 is connected. STP 108 may query database 116 to obtain information relating to the CgPN of caller A's telephony device 102. Database 116 may send a response containing information associated with caller A's telephony device 102. Message 6 represents an SMS message from messaging application 121 on STP 108 to parent's mobile device 104 containing information associated with caller A's telephony device 102 and child's mobile device 106. Message 7 represents an SMS response from parent's mobile device 104 to messaging application on STP 108, containing instruction information to allow the call. Upon receipt of instruction to allow the call, STP 108 sends a CUE message to the SSP or MSC connected to caller A's telephony device 102 to instruct the SSP or MSC that it may continue normal call setup activities. Message 9 represents an ISUP IAM, containing the CdPN of the child's mobile device 106 and CgPN of caller A's telephony device 102, sent from the SSP or MSC connected to caller A's telephony device 102 to MSC 102, which is connected to child's mobile device 106. MSC 112 sends a RAN call setup message to child's mobile device 106 in order to establish the voice path of the call.

In one embodiment, the call may be rejected instead of allowed. For example, parent's mobile device 104 sends an SMS response message back to messaging application on STP 108 stating that the call should be rejected. Messaging application 121 may process the reply SMS and forward the instruction information to parental control application 120. Parental control application 120 may instruct STP 108 to perform an action based on the instruction information in the response SMS. Upon receipt of an allowance message, STP 108 issues a response to caller A's telephony device to release the call.

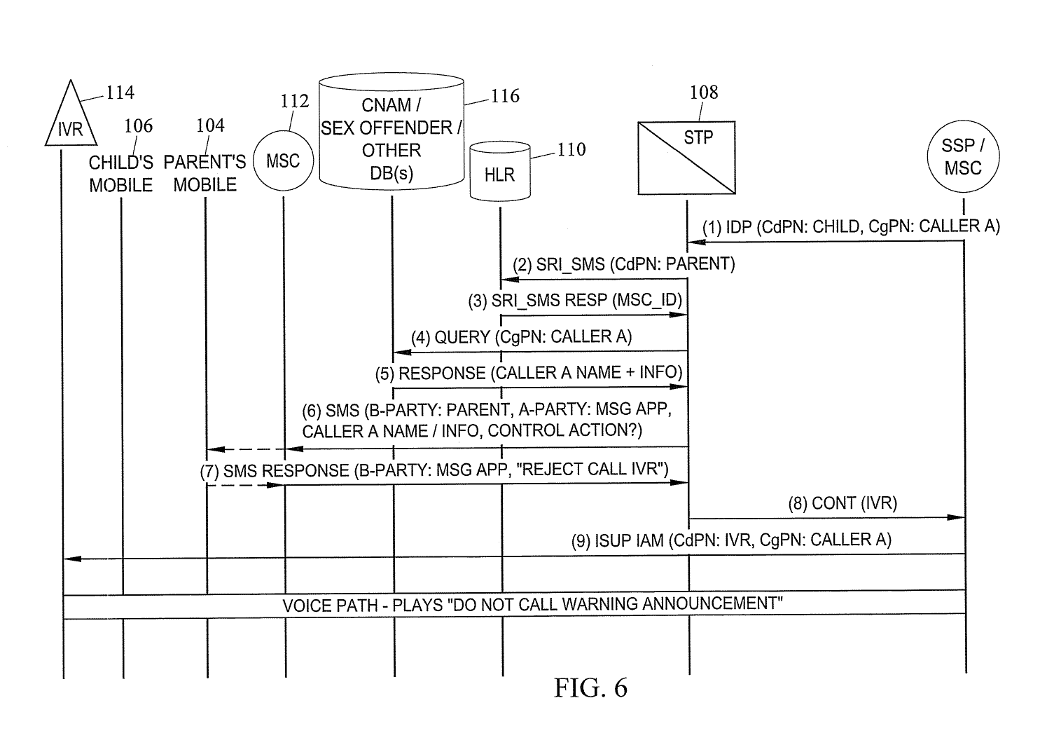

FIG. 6 is a diagram illustrating an exemplary call flow for an IN/AIN trigger-based parental control implementation of the present subject matter wherein the called party is the monitored child and the call is rejected. Parent's mobile device 104 is the monitoring device in this embodiment. Messages 1-6 of FIG. 6 are identical to messages 1-6 discussed in FIG. 5, and therefore will not be discussed. Message 7 is a SMS response from parent's mobile device 104 instructing parental control application 120 to reject the call from caller A's telephony device 102 to child's mobile device 106. Message 7 may also include an instruction to forward the call to a recorded message stored on IVR 114. Upon receipt of instruction to reject and forward the call to IVR 114, STP 108 may send a message to the SSP or MSC connected to caller A's telephony device 102. Message 8 is an instruction given to the SSP or MSC communicatively connected to caller A's telephony device 102 to continue the call, but the connection established includes the specified IVR 114 instead of the child's mobile device 106. Upon receipt of this CONTINUE message 8, the SSP or MSC connected to caller A's telephony device 102 may generate an ISUP IAM, containing a CdPN field populated with information associated with IVR 114, and CgPN populated with information associated with caller A's telephony device 102. Once a voice path is established between caller A's telephony device 102 and IVR 114, the IVR may play a pre-recorded warning message. This warning message may, for example, notify caller A that he/she may not contact child's mobile device 106. In another embodiment, instead of creating a voice path between the calling party and IVR 114, a voice path between the calling party and the parent mobile device 104 may be established.

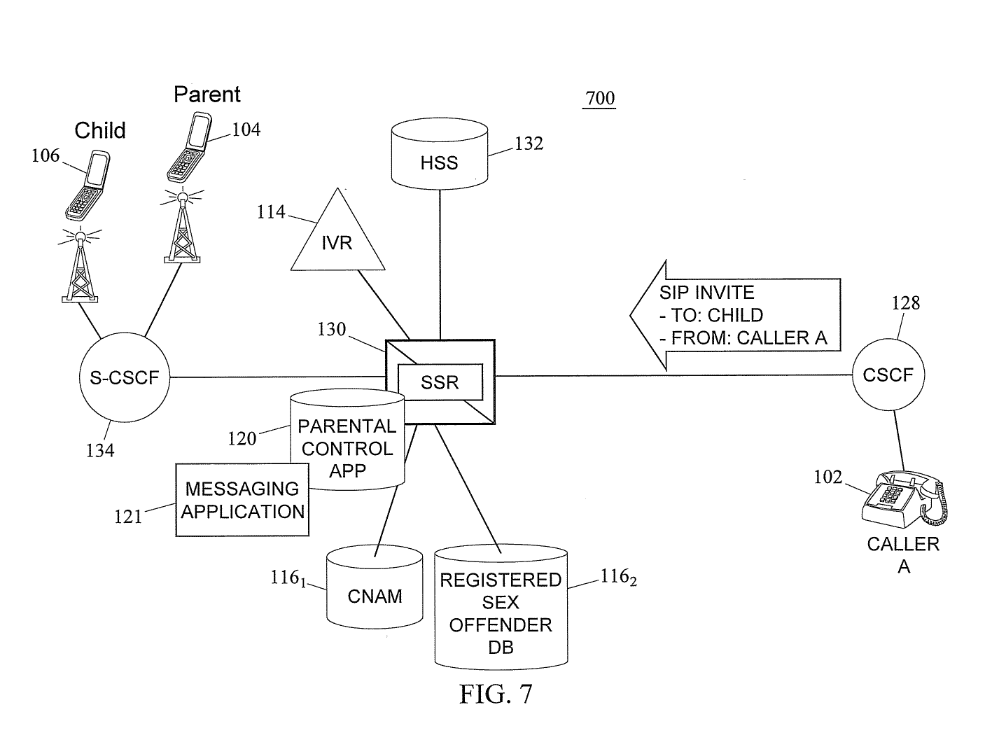

FIG. 7 is a block diagram illustrating an exemplary embodiment of a network 700 implementing systems, methods, and computer readable media for third party monitoring and control of calls. This embodiment illustrates SIP Invite intercept-based parental control implementation. In this embodiment, parental control application 120 on a SIP signaling router (SSR) 130 is adapted to intercept a SIP Invite message associated with a call from a calling party, caller A's telephony device 102, to child's mobile device 106, where parent's mobile device 104 is subscribed to the parental control service. SSR 130 may include, among other modules, a parental control application 120, which includes a messaging application or module 121. In one embodiment, SSR 130 performs the STP routing functions in an LTE network and may include a processing unit to operate the applications/modules. In another embodiment, an application server may be utilized in network 700 instead of SSR 130 without departing from the scope of the present subject matter. Parental control application 120 may be provisioned to intercept the SIP Invite message and determine that the call is destined for child's mobile device 106, and may determine that child's mobile device 106 is subscribed to the parental control service. SSR 130 may hold the SIP Invite and perform parental control related processing and signaling in order to determine whether the call should be allowed to proceed or should be rejected or blocked, among other actions. Parental control related processing may include querying a database 116 to obtain information about caller A's telephony device 102. Database 116 may include, for example, a CNAM database 116₁ or registered sex offender database 116₂. Caller A's telephony device 102 may be connected to SSR 130 via a CSCF 128. SSR 130 may be connected to a Home Subscriber Server (HSS) 132. In this embodiment, parent's mobile device 104 and child's mobile device 106 are connected to SSR 130 via a Serving Call Session Control Function (S-CSCF) 134. Network 700 may also include an IVR server 114 for playing prerecorded messages to parties. In one embodiment, the same or different calling party (i.e., caller B) may use a mobile calling device 124 that utilizes a gateway mobile switching center (GMSC) 126 instead of an end office 103 to communicate with SSR 130.

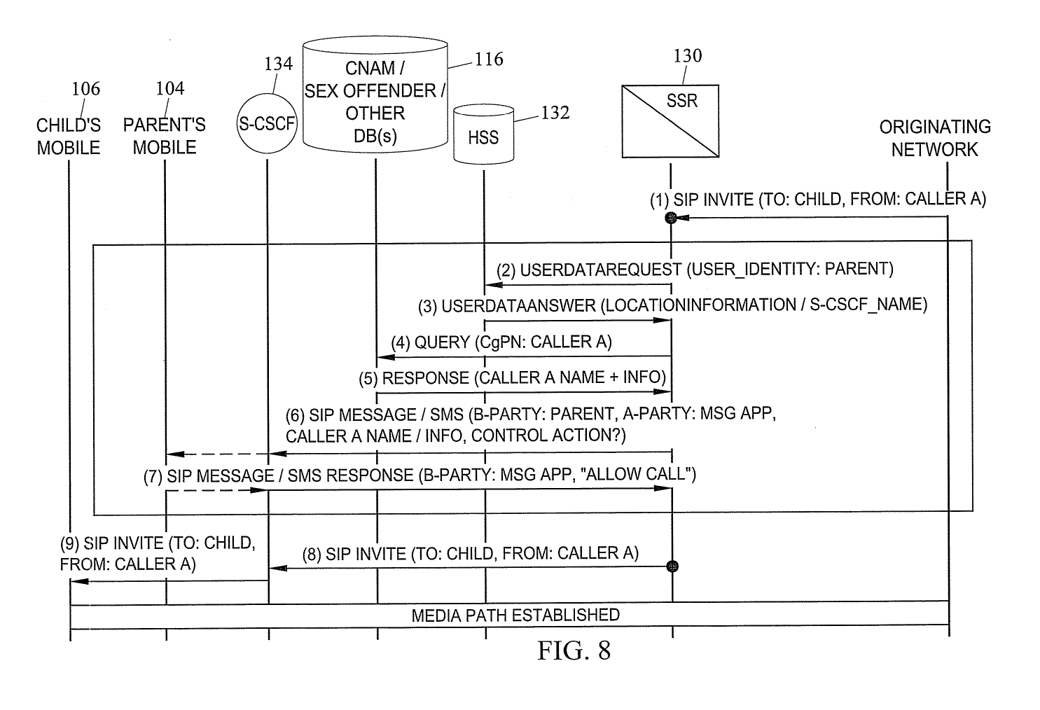

FIG. 8 is a diagram illustrating an exemplary call flow for a SIP trigger-based parental control implementation of the present subject matter wherein the called party is the monitored child and the call is allowed. Parent's mobile device 104 is the monitoring device in this embodiment. Message 1 represents a SIP Invite from caller A's telephony device 102 to child's mobile device 106. SIP Invite is received at SSR 130. Parental control application 120 informs SSR 130 that child's mobile device 106 is subscribed to third party monitoring by parent's mobile device 104. SSR 130 may then generate a User Data Request message and forward it to HSS 132. The User Data Request message may contain information associated with parent's mobile device 104 in order for SSR 130 to obtain routing information for parent's mobile device 104. Message 3 represents a User Data Answer message containing routing information associated with parent's mobile device 104. Routing information may include, for example, the location of parent's mobile device 104, as well as the name of S-CSCF 134 communicatively connected to parent's mobile device 104. SSR 130 may generate a query message to a database 116 in order to obtain information associated with caller A's telephony device 102. Message 5 represents a response to the query message, which may contain information associated with caller A's telephony device 102. In other embodiments, messaging application 121 on SSR 130 may send a SMS message to parent's mobile device 104, containing information associated with the child's mobile device 106 and caller A's telephony device 102. Message 6 may also include information associated with messaging application 121, as well as possible control actions that parent's mobile device 104 may respond with. Message 6 may, for example, be a SIP message or an SMS message, as well as an instant message or email message. Parent may reply to message 6 via mobile device 104. In one embodiment, message 7 includes an instruction to allow the call to proceed. Since message 7 contains instruction information to allow the call, parental control application 120 may direct SSR 130 to proceed with normal call setup activity. SSR 130 may forward the initial SIP Invite to S-CSCF 134, which may be communicatively connected to child's mobile device 106, S-CSCF 134 may forward the SIP Invite to child's mobile device 106. Call setup may continue until a media path is established and caller A's telephony device 102 can communicate with child's mobile device 106.

In one embodiment, the call may be rejected instead of allowed. For example, parent's mobile device 104 sends an SMS response message back to messaging application on STP 108 stating that the call should be rejected. Messaging application 121 may process the reply SMS and forward the instruction information to parental control application 120. Parental control application 120 may instruct SSR 130 to perform an action based on the instruction information in the response SMS. Upon receipt of an allowance message, SSR 130 issues a SIP Cancel or Bye message to caller A's telephony device to release the call.

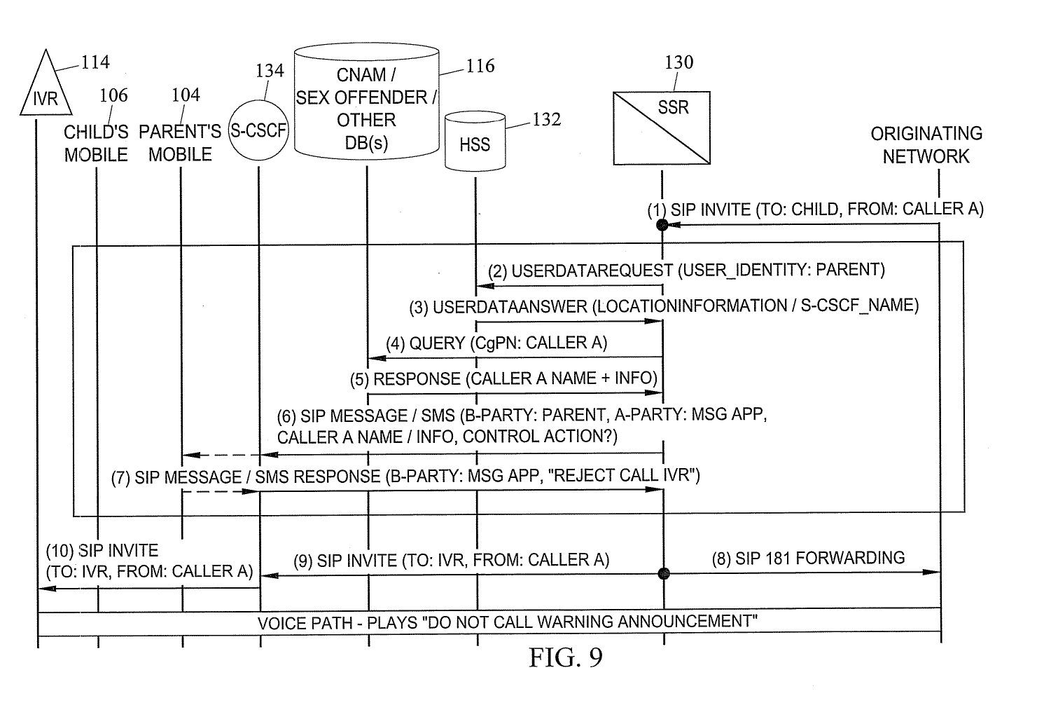

FIG. 9 is a diagram illustrating an exemplary call flow for a SIP trigger-based parental control implementation of the present subject matter wherein the called party is the monitored child and the call is rejected. Parent's mobile device 104 is the monitoring device in this embodiment. Messages 1-6 in FIG. 9 are identical to messages 1-6 in FIG. 8, and therefore description of these messages will not be repeated. Message 7 is a reply message received by messaging application 121 on SSR 130, and contains instructions to reject the call and to forward the call to IVR 114. SSR 130 may send a SIP 181 forwarding message to caller A's telephony device 102 notifying caller A's telephony device 102 of a new forwarding address, which may be the address of IVR 114. SSR 130 also may send a SIP Invite to S-CSCF 134 communicatively connected to IVR 114, notifying S-CSCF 134 that the message originated from caller A's telephony device 102 and is destined for IVR 114. S-CSCF 134 may forward the SIP Invite to IVR 114. Normal call setup may proceed until a voice path is established between IVR 114 and caller A's telephony device 102. IVR 114 may play a prerecorded message, which may include a warning to caller A to not call child's mobile device 106. In another embodiment, instead of creating a voice path between the calling party and IVR 114, a voice path between the calling party and the parent mobile device 104 may be established.

In some embodiments, STP 108 or SSR 130 may be provisioned to only perform monitoring and control for certain calls originating from or terminating to a monitored party. For example, the monitoring party may designate or assign certain third parties to a white list or a black list. If a third party is on a white list, STP 108 or SSR 130 may also forgo the monitoring process for attempted communications between monitored party and third party, and instead proceed with normal call setup. If, on the other hand, a third party is on a black list, STP 108 or SSR 130 may not initiate monitoring process for attempted communications between monitored party and third party, and may instead immediately block the call session. The monitoring party may populate the black list and white list by utilizing different methods. For example, upon receipt of a notification message from STP 108 or SSR 130, monitoring party may instruct STP 108 or SSR 130 to add the third party to either the white list or the black list. This instruction may be a response to a short code associated with one of these options. The parent may also opt to take no action regarding placing the third party on a white or black list. Another method for populating the white list and black list is the monitoring parent may utilize a web or web-like interface to designate various call party names or numbers to the white list and black list.

In one embodiment, STP 108 or SSR 130 may be provisioned with specific rules to determine when to solicit call control action from the monitoring party. Some examples of rules that may be provisioned in parental control application 120 that are triggered upon receiving a call signaling message include soliciting a control input from the monitoring third party for all inbound calls to the child's phone, soliciting a control input from the monitoring third party for all outbound calls from the child's phone, soliciting a control input from the monitoring third party for calling/called parties that are not included on a white list, and soliciting a control input from the monitoring third party for some or all calls during a predefined time period and/or date/day of week. Other examples include soliciting a control input from the monitoring third party for some or all inbound/outbound calls to one or more area codes and soliciting a control input from the monitoring third party for some or all inbound/outbound calls to one or more URI domain names (e.g., anyname@drugdeal.com, etc.)

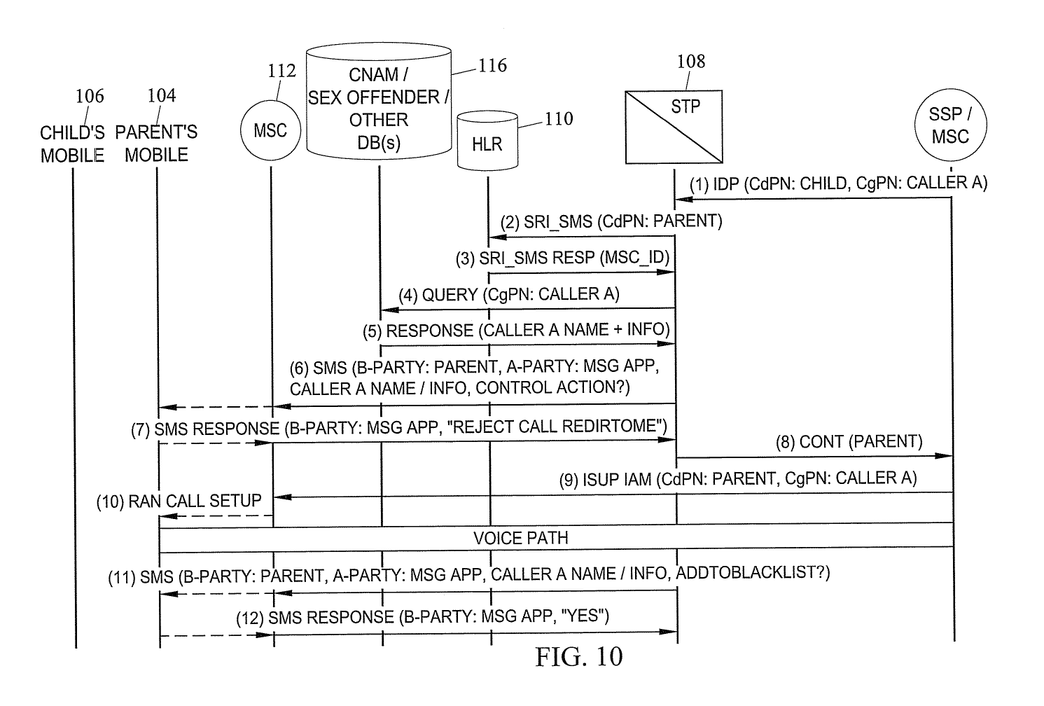

FIG. 10 is a diagram illustrating an exemplary call flow for an IN/AIN trigger-based parental control implementation of the present subject matter wherein the called party is the monitored child, the call is rejected, the call is redirected to the monitoring party, and the third party is added to a blacklist. Parent's mobile device 104 is the monitoring device in this embodiment. Messages 1-6 of FIG. 10 are similar to messages 1-6 in FIG. 5. Descriptions of these messages will not be repeated here. Message 7 is a reply message from parent's mobile device 104 which may instruct STP 108 to reject the call and redirect the call to parent's mobile device 104. Message 8 represents instruction information given to the SSP or MSC connected to caller A's telephony device 102 to continue the call, but to connect to parent's mobile device 104 instead of child's mobile device 106. Upon receipt of this CONTINUE message, the SSP or MSC connected to caller A's telephony device may generate an ISUP IAM, including CdPN of parent's mobile device 104, and CgPN of caller A's telephony device 102. MSC 112 may send a RAN call setup message to parent's mobile device 104, and call setup may continue until a voice path is established between caller A's telephony device 102 and parent's mobile device 104. During call teardown, messaging application 121 may send a message to parent's mobile device 104 containing information associated with caller A's telephony device 102. Message 11 may query parent's mobile device to determine whether to add caller A's telephony device 102 to the black list. In this embodiment, parent's mobile device 104 replies with an SMS message indicating a yes—add to blacklist. Parental control application 120 may register the response and place caller A's telephony device 102 on the black list. Until caller A's telephony device 102 is removed from the black list, caller A's telephony device may not be allowed to complete calls to child's mobile device 106, and vice versa.

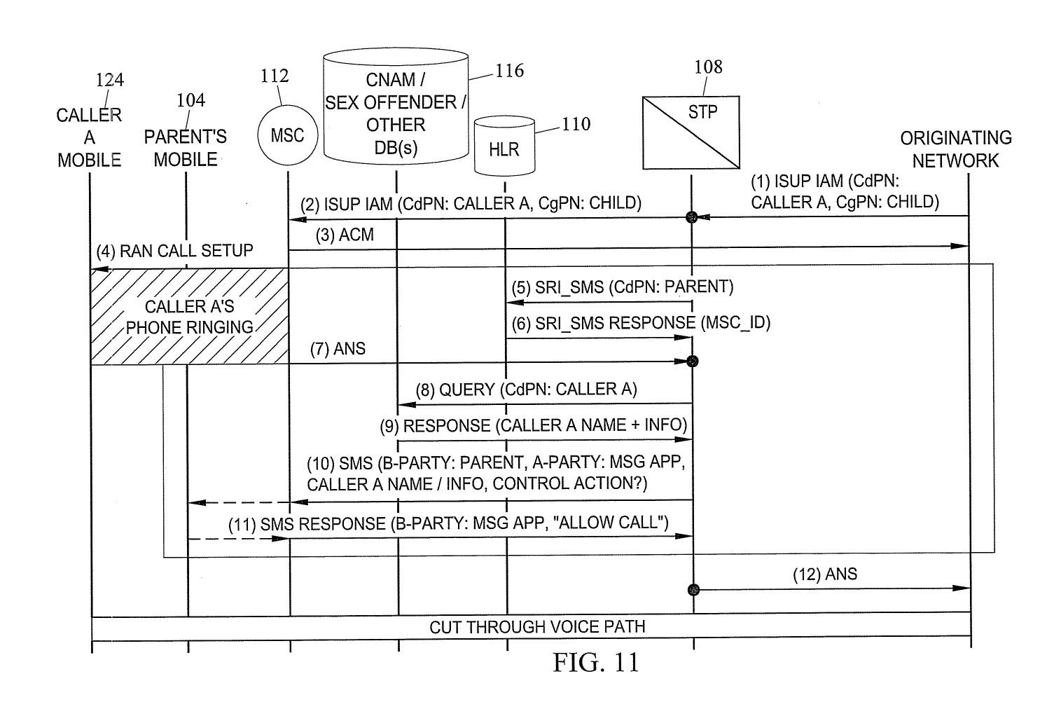

FIG. 11 is a diagram illustrating an exemplary call flow for a triggerless ISUP-intercept based parental control implementation of the present subject matter wherein the call originates from an SS7 network, the calling party is the monitored child, and the call is allowed. Parent's mobile device 104 is the monitoring device in this embodiment. Message 1 represents an ISUP IAM, containing CdPN information associated with caller A's mobile device 124, and CgPN information associated with the child's telephony device. Message 1 may be received at STP 108. STP 108 may forward the ISUP IAM to MSC 112, which may be connected to caller A's mobile device 124. MSC 112 may send an ACM message to the originating network to which caller A's mobile device 124 is connected. MSC 112 may also send a RAN call setup message to caller A's mobile device 124. A possible outcome of caller A's mobile device 124 receiving the RAN call setup message is caller A's mobile device 124 ringing. Message 5 represents an SRI_SMS lookup from STP 108 to HLR 110. The SRI_SMS lookup may include information associated with parent's mobile device 104 in a message parameter. HLR 110 may send a SRI_SMS response to STP 108, which may contain the MSC ID of MSC 112 which is communicatively connected to parent's mobile device 104. Message 7 represents an answer message from MSC 112, which is communicatively connected to caller A's mobile device 124, to STP 108. STP 108 may then buffer the answer message until it receives monitoring and control information from parent's mobile device 104. STP 108 may query a database 116 to obtain information associated with caller A's mobile device 124 by sending a query message to database 116. Database 116 may reply with a response containing information associated with caller A's mobile device 124. Message 10 represents a message from messaging application 121 on STP 108 to parent's mobile device 104 containing information associated with the child's telephony device and caller A's mobile device 124. Message 10 may also include possible control actions. In message 11, parent's mobile device 106 sends a SMS reply with instruction information to allow the call. Upon receiving the instruction information to allow the call, STP 108 may forward the buffered answer message to the originating network, and normal call setup may continue, creating a voice path between the child's telephony device and user A's mobile device 124.

In one embodiment, the call may be rejected instead of allowed. For example, parent's mobile device 104 sends a Reject SMS response message back to messaging application on STP 108 stating that the call should be rejected. Messaging application 121 may process the Reject SMS and forward the instruction information to parental control application 120. Parental control application 120 may instruct STP 108 to perform an action based on the instruction information in the response SMS. Upon receipt of an allowance message, STP 108 issues a SRI_SM Response message to caller A's telephony device to bar the call.

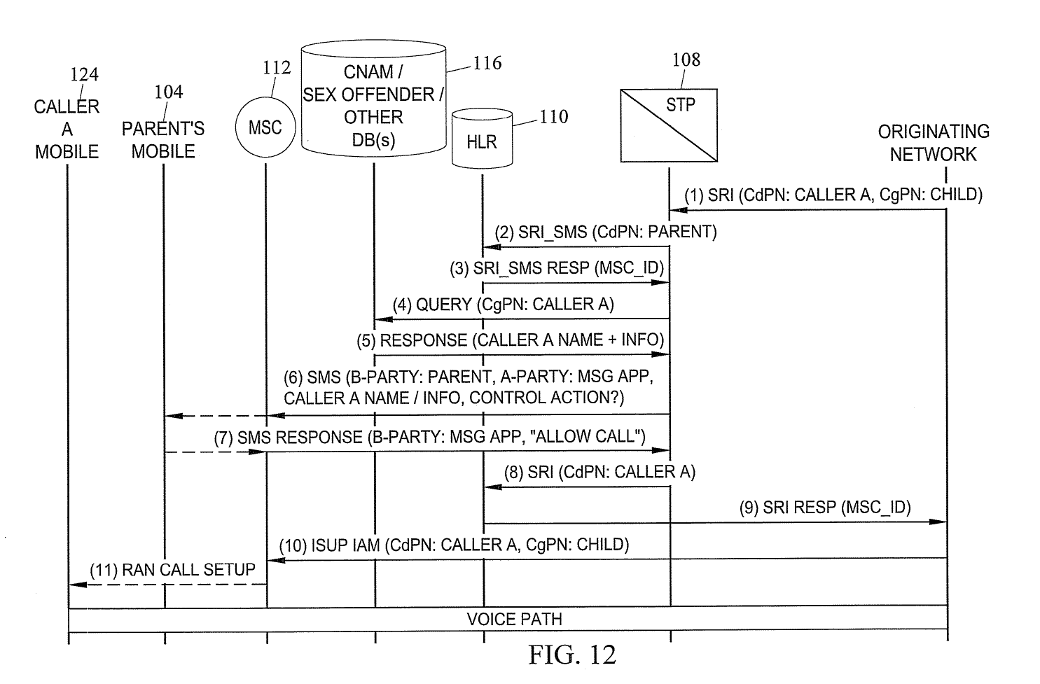

FIG. 12 is a diagram illustrating an exemplary call flow for a triggerless ISUP-intercept based parental control implementation of the present subject matter, wherein the call originates from an SS7 network, the calling party is the monitored child, and the call is allowed. Parent's mobile device 104 is the monitoring device in this embodiment. Message 1 represents a SRI query message, which may include the CdPN of caller A's mobile device 124 and CgPN child's telephony device. STP 108 may buffer an incoming SRI query message until it receives instruction information from parental control application 120. Upon determining that the child's telephony device is subscribed to monitoring and control service, STP 108 may send an SRI_SMS query to HLR 110 to obtain routing information associated with parent's mobile device 104 (the parents being the monitoring party). HLR 110 may send a SRI_SMS response containing the MSC ID of MSC 112 which is connected to parent's mobile device 104. STP 108 may query a database 116 to obtain information associated with caller A's mobile device 124. This query may contain the CdPN or any other information associated with caller A's mobile device 124. Database 116 may reply with information associated with caller A's mobile device 124. Message 6 represents a SMS sent from messaging application on STP 108 to parent's mobile device 104. SMS may contain information associated with caller A's mobile device 124 and child's telephony device. Parent's mobile device 104 may reply to the SMS with another SMS via parent's mobile device 104, wherein the SMS from parent's mobile device 104 may include control actions associated with the call. In the present embodiment, the control action is to allow the call. Upon receiving instruction information to allow the call, STP 108 may forward the buffered SRI query to HLR 110 in order to obtain routing information associated with caller A's mobile device 124. HLR 110 may reply with a SRI response, which may include routing information associated with caller A's mobile device 124. Message 9 may be forwarded directly to the originating network connected to child's telephony device. Message 10 represents an ISUP IAM originating from the originating network communicatively connected to child's telephony device and being delivered to MSC 112, which is communicatively connected to caller A's mobile device 124. Normal call setup continues until a voice path is established between caller A's mobile device 124 and child's telephony device.

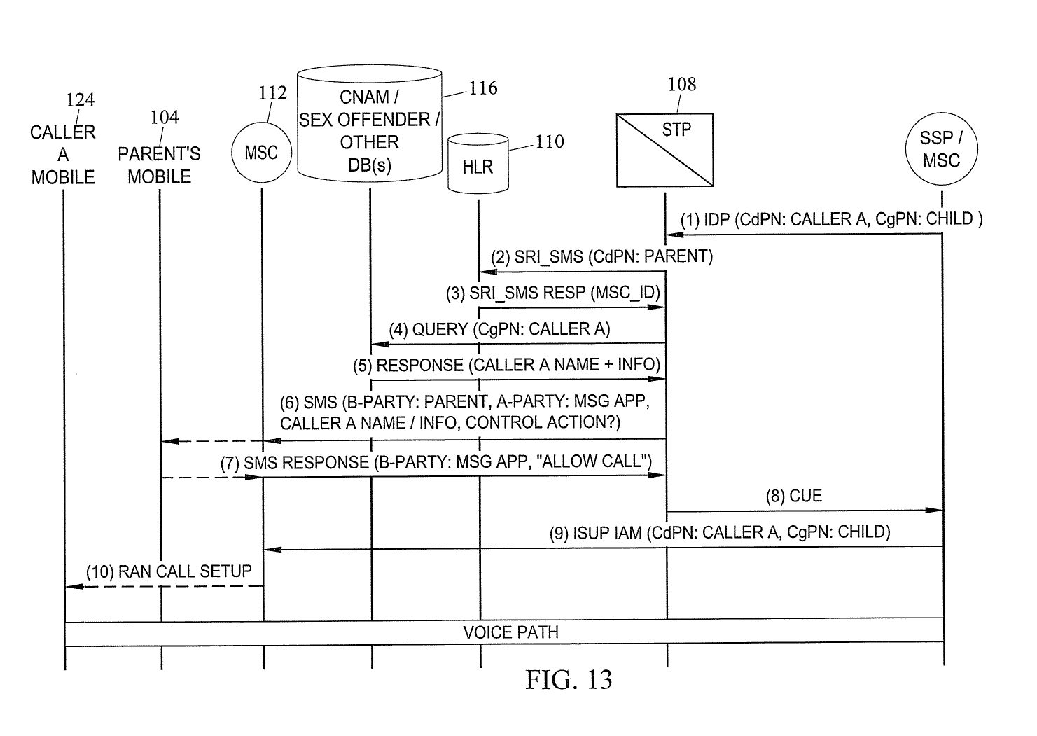

FIG. 13 is a diagram illustrating an exemplary call flow for an IN/AIN trigger-based parental control implementation of the present subject matter wherein the calling party is the monitored child and the call is allowed. Parent's mobile device 104 is the monitoring device in this embodiment. Message 1 is an initial detection point (IDP) message which may include the CdPN of caller A's mobile device 124 and CgPN of child's telephony device. The IDP is sent from an SSP or MSC to STP 108. Upon receipt of the IDP, parental control application 120 may determine, based on the CgPN, that the calling party (child's telephony device) is subscribed to the monitoring service. STP 108 may send an SRI_SMS query to HLR 110, to determine routing data in order to send an SMS to parent's mobile device 104. HLR 110 may send an SRI_SMS response message to STP 108, containing the MSC ID of MSC 112, to which parent's mobile device 104 is communicatively connected. STP 108 may query database 116 in order to obtain information associated with the CdPN of caller A's mobile device 124. Database 116 may reply with a response message containing information associated with caller A's mobile device 124. Message 6 represents a SMS from messaging application on STP 108 to parent's mobile device 104 which may contain information associated with caller A's mobile device 124 and child's telephony device. Message 7 represents an SMS response from parent's mobile device 104 to messaging application on STP 108, containing instruction information to allow the call. Upon receipt of the instruction information to allow the call, STP 108 may send a CUE message to the SSP or MSC connected to child's telephony device to instruct the SSP or MSC that it may continue normal call setup activities. Message 9 represents an ISUP IAM, which may include the CdPN of caller A's mobile device 124 and CgPN of child's telephony device, sent from the SSP or MSC communicatively connected to child's telephony device to the MSC 102 communicatively connected to caller A's mobile device 124. MSC 112 may send a RAN call setup message to caller A's mobile device 124 in order to continue establishment of the call.

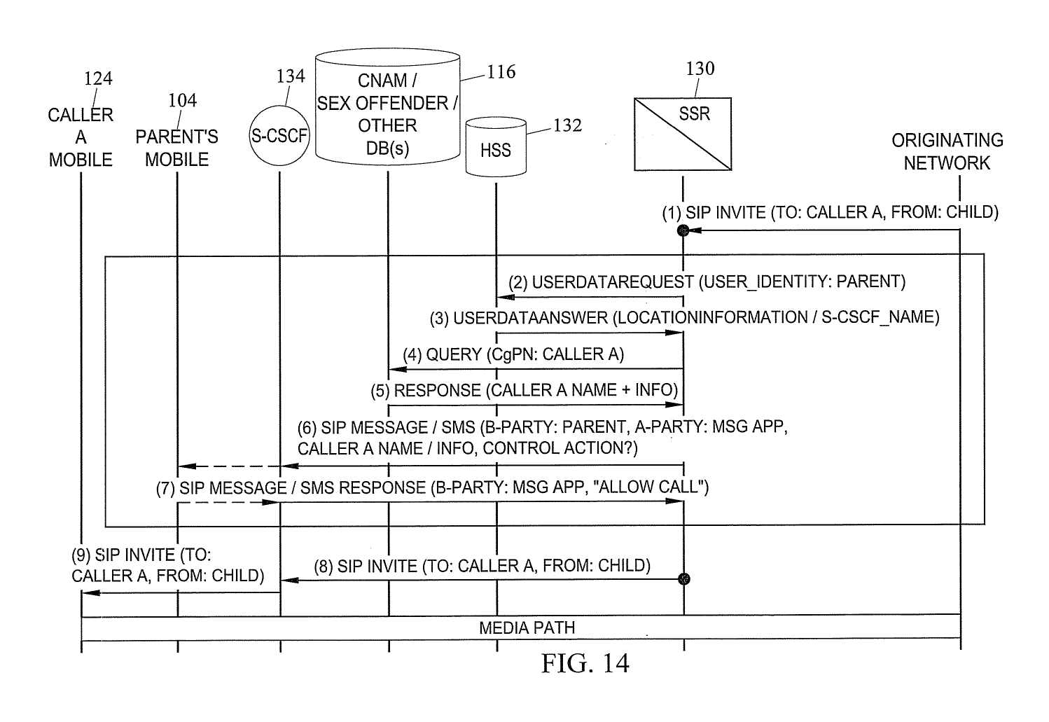

FIG. 14 is a call flow diagram illustrating an exemplary call flow for a SIP trigger-based parental control implementation of the present subject matter wherein the calling party is the monitored child and the call is allowed. Parent's mobile device 104 is the monitoring device in this embodiment. Message 1 represents a SIP invite from the child's telephony device to the caller A's mobile device 124. SIP invite may be received at SSR 130. Parental control application 120 may inform SSR 130 that child's telephony device is subscribed to third party monitoring by the parent's mobile device 104. SSR 130 may then generate a User Data Request message and forward the message to HSS 132. The User Data Request message may contain information associated with parent's mobile device 104, in order for SSR 130 to obtain routing information associated with parent's mobile device 104. Message 3 represents a User Data Answer message containing routing information associated with parent's mobile device 104. Routing information may include the location of parent's mobile device 104, as well as the name of the S-CSCF which is communicatively connected to parent's mobile device 104. SSR 130 may generate a query message to database 116 in order to obtain information associated with caller A's mobile device 124. Message 5 represents a response to the query message, which may contain information associated with caller A's mobile device 194. Messaging application on SSR 130 may send a message to parent's mobile device 104, which may contain information associated with the child's telephony device and caller A's mobile device 124. Message 6 may also include possible control actions parent's mobile device 104 may respond with. Message 6 may, for example, be a SIP message or an SMS message. Parent may reply to message 6 via mobile device 104. In the current embodiment, message 7 includes instruction information to allow the call to proceed. Since message 7 contains instruction information to allow the call, parental control application 120 may direct SSR 130 to proceed with normal call setup activity. SSR 130 may forward the initial SIP invite to S-CSCF 134, which is connected to caller A's mobile device 124. S-CSCF 134 may forward the SIP invite to caller A's mobile device 124. Call setup continues until a media path is established and caller A's mobile device 124 can communicate with child's telephony device.

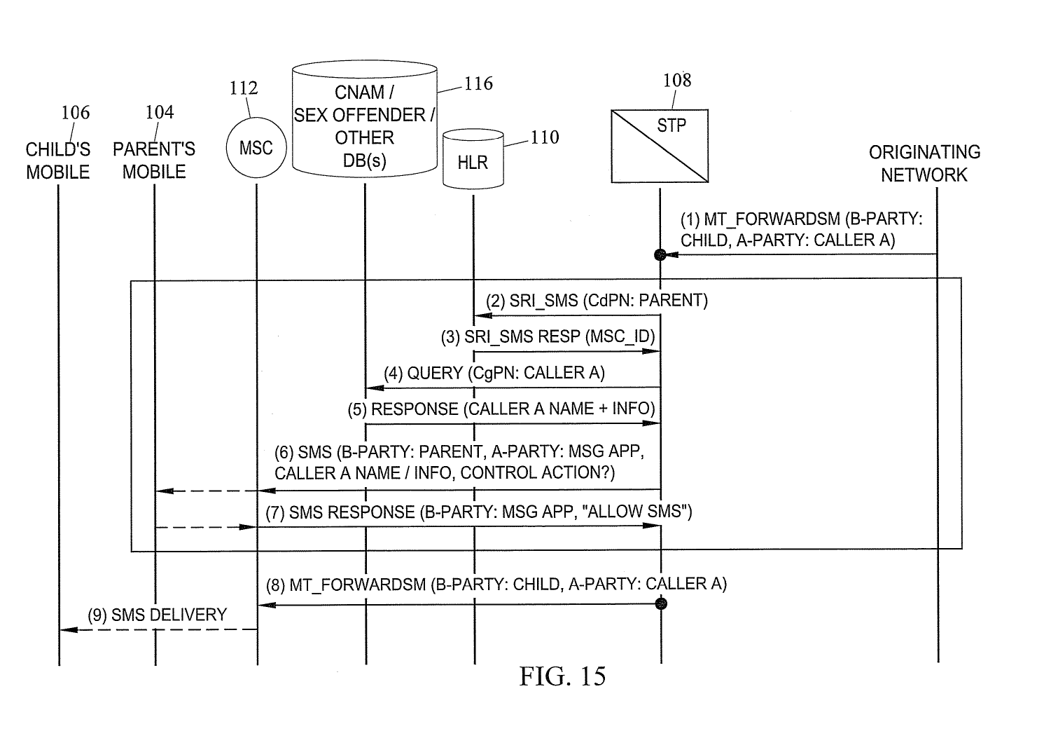

FIG. 15 is a call flow diagram illustrating an exemplary call flow for a SMS trigger-based parental control implementation of the present subject matter wherein the receiving party is the monitored child and the SMS is allowed. Parent's mobile device 104 is the monitoring device in this embodiment. Message 1 represents a Mobile Terminated Forward Short Message (MT_ForwardSM) from the originating network communicatively connected to caller A's telephony device and terminating at STP 108. MT_ForwardSM may list child's mobile device 106 as the recipient of the message and caller A's telephony device as the originator of the message. STP 108 may buffer MT_ForwardSM until it receives instruction information relating to monitoring and control of parties associated with message 1. In one embodiment, parental control application 120 may inform STP 108 that child's mobile device 106 is subscribed to monitoring service, and that parent's mobile device 104 is the monitoring device. STP 108 may send an SRI_SMS query to HLR 110 requesting routing information associated with parent's mobile device 104. HLR 110 may send an SRI_SMS response to STP 108 which may contain routing information associated with parent's mobile device. STP 108 may query database 116 to obtain information associated with caller A's telephony device, and database 116 may provide a response containing information associated with caller A's telephony device. Messaging application on STP 108 may send an SMS to parent's mobile device 104 containing information associated with caller A's telephony device and child's mobile device. Parent's mobile device 104 may reply with instruction information associated with handling the SMS from caller A's telephony device to child's mobile device 106. In this example, parent's mobile device 104 replies with instructions to allow the SMS. Upon receipt of instruction information to allow the SMS, STP 108 may forward the buffered MT_ForwardSM to MSC 112, which is communicatively connected to child's mobile device 106. MSC 112 may then deliver the SMS to child's mobile device 106.

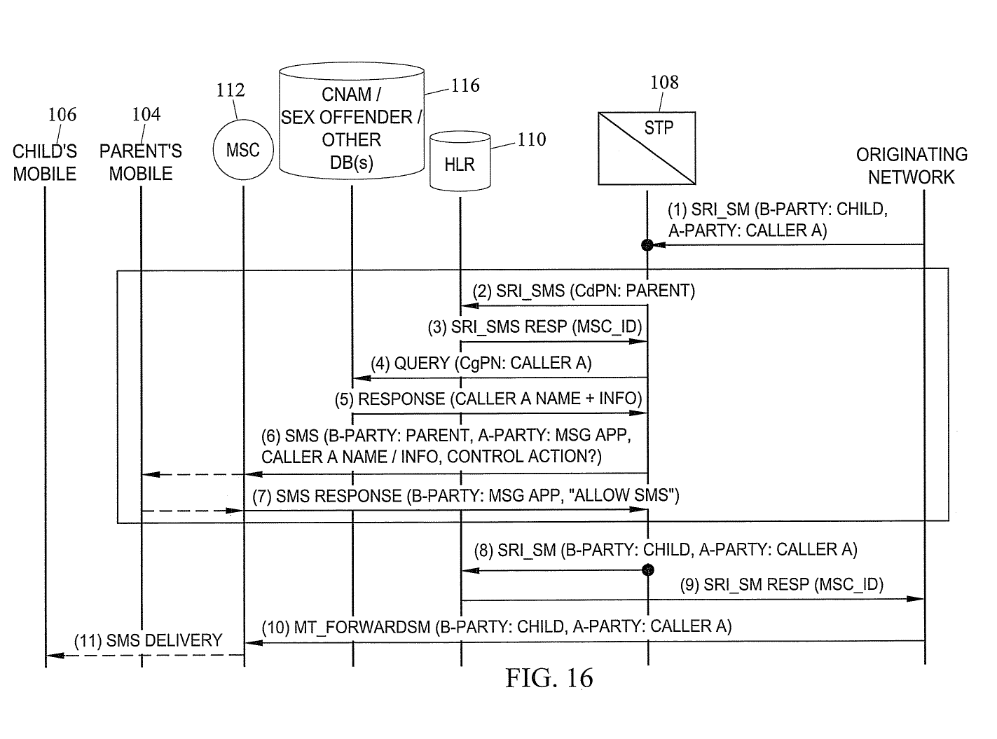

FIG. 16 is a call flow diagram illustrating an exemplary call flow for a SRI short message based parental control implementation of the present subject matter, wherein the receiving party is the monitored child and the message is allowed. Parent's mobile device 104 is the monitoring device in this embodiment. Message 1 is a routing information for short message request (SRI_SM) originating from an originating network connected to caller A's telephony device. Message 1 lists the child's mobile device 106 as the receiving party and caller A's telephony device as the sending party. STP 108 may buffer the SRI_SM until it receives control information associated with the message. STP 108 may query HLR 110 to obtain routing information associated with parent's mobile device 104. HLR 110 may reply with routing information associated with parent's mobile device 104. STP 108 may query database 116 to obtain information associated with caller A's telephony device. Database 116 may reply with information associated with caller A's telephony device. Message 6 represents an SMS from messaging application on STP 108 to parent's mobile device 104, which may contain information associated with caller A's telephony device and information associated with child's mobile device 106, as well as possibly including available control actions. Message 7 represents an SMS reply from parent's mobile device 104, which may contain instruction information to allow the message. Upon receipt of instruction information to allow the SMS, STP 108 may forward the buffered SRI_SM message to the HLR 110 in order to receive routing information associated with child's mobile device 106. HLR 110 may reply with an SRI_SM response, which may include routing information associated with child's mobile device 106. Upon receipt of SRI_SM response, the originating network may send an MT_ForwardSM to MSC 112, which is communicatively connected to child's mobile device 106. MSC 112 may deliver the SMS to child's mobile device 106.

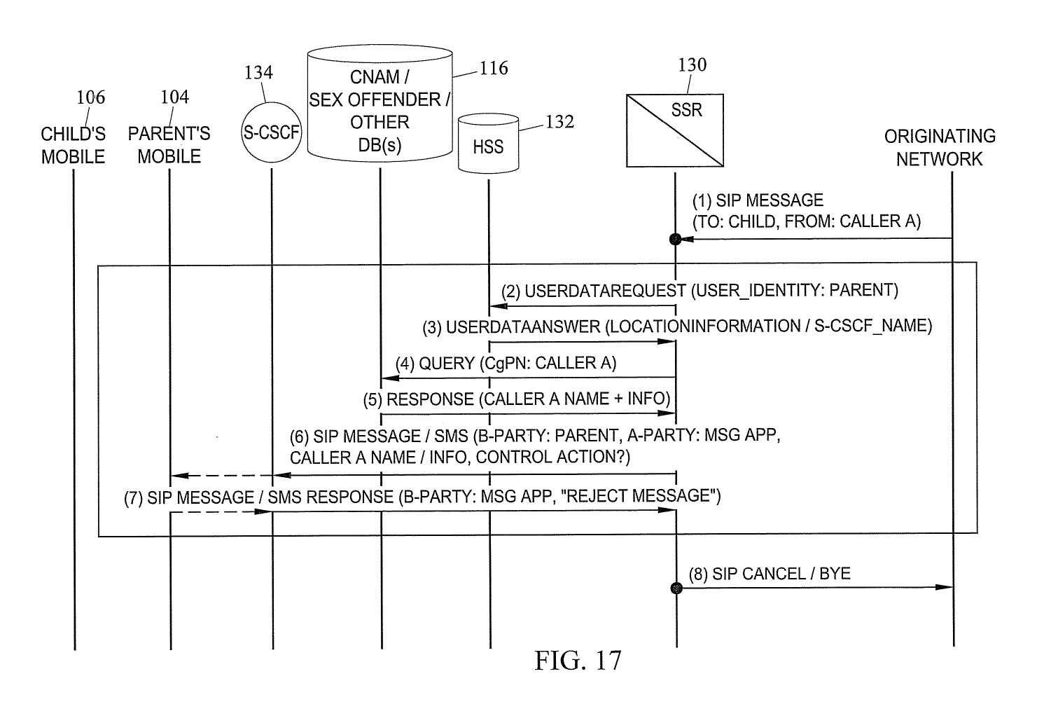

FIG. 17 is a call flow diagram illustrating an exemplary call flow for a SIP trigger-based parental control implementation of the present subject matter wherein the called party is the monitored child and the call is rejected. Parent's mobile device 104 is the monitoring device in this embodiment. Message 1 represents a SIP Message originating from caller A's telephony device and directed to child's mobile device 106. Messages 2-6 of FIG. 17 represent similar messages as messages 1-6 of FIG. 8. Therefore discussion of these messages will be omitted. Message 7 represents a SMS reply to messaging application on SSR 130. In one embodiment, SMS reply contains instruction information to reject the message. Upon receiving instruction information from parental control application 120 to reject the call, SSR 130 sends a SIP cancel/bye message to caller A's telephony device.

In one embodiment, additional control may be needed from the monitoring party regarding when to notify or not notify the monitored party, and whether the monitoring system (e.g., the parental control application 120) should wait or not for response in order to continue with call setup. In addition, the monitoring party may be provided the ability to make the current response to only apply to the current call or, alternatively, apply to future calls as well. For example, there may be additional control from the monitoring party associated with when to notify the monitoring party, when to require permission from the monitoring party to establish the call, and when to reject the call always. The monitoring party may provide instruction to parental control application 120 to provision data and/or instructions to a white list or black list. Examples include, but are not limited to:
White List with Notify—Allow these calls to be handled normally on this list but notify the monitoring third party
White List without Notifications—Allow these calls to be handled normally and do not notify the monitoring third party
Black list with Notify—Block these calls and also notify the monitoring third party
Black list without Notifications—Block these calls and also notify the monitoring third party
All other call party numbers are Notify by default and require an affirmative response by the monitoring third party to complete the call
   Likewise the monitoring third party may desire the current control that applies to current calls to also apply to future calls. For example, responses may include:
Allow (i.e., Allow this call involving this call party number)
Allow all (i.e., allow this call involving this call party and all future calls involving the call party number)
Block (i.e., block this call involving this call party number)
Block all (i.e., block all future call involving this call party number)
Redirect to monitoring third party device
Redirect to Prerecorded Message at an IVR server

In one embodiment, the present subject matter may relate to a parent monitoring a child's messages and calls. In other embodiments, a non-custodial relationship may exist between monitoring and monitored parties, for example, between a manager and employee. In these custodial embodiments, some authorization from the original called party (if the called party is the monitored party) or original calling party (if the calling party is the monitored party) is required. For example, the monitored party may be made aware of the third party notification and the response. For example, an SMS message notification to the monitored party may be sufficient.

It will be understood that various details of the subject matter described herein may be changed without departing from the scope of the subject matter described herein. Furthermore, the foregoing description is for the purpose of illustration only, and not for the purpose of limitation.

What is claimed is:

1. A system for third party control of call communications to a monitored called party, the system comprising:
a signaling node for receiving a signaling message indicating an attempted call communication to a called party device from a calling party device; and
a parental control module in the signaling node for:
determining if the called party device is subscribed to a call monitoring service, for sending a notification message to a monitoring third party device associated with the called party device in response to determining the called party device is subscribed to the call monitoring service, wherein the notification message indicates the attempted call communication between the called party device and the calling party device;
receiving a response to the notification message from the third party device; and
determining whether or not to allow the attempted call communication to proceed between the monitored called party device and calling party device based on the response from the monitoring third party device.

2. The system of claim 1 wherein the notification message to the third party device includes at least one of a short message service (SMS) message, an email message, an instant message, and a multimedia message service (MMS) message.

3. The system of claim 1 wherein the response from the third party device includes at least one of a short message service (SMS) message, an email message, an instant message, and a multimedia message service (MMS) message.

4. The system of claim 1 wherein the parental control module is further configured for querying at least one database to obtain information corresponding to a calling party associated with the calling party device.

5. The system of claim 4 wherein the database includes at least one of a calling party name (CNAM) database containing calling party identification information corresponding to a calling party associated with the calling party device, a sex offender database containing sex offender status information corresponding to a calling party associated with the calling party device, a subscriber blacklist, and a subscriber white list.

6. The system of claim 4 wherein the notification message includes the information obtained from the at least one database.

7. The system of claim 1 wherein the signaling message includes at least one of a call setup message, a forward short message (ForwardSM) message, and a send routing information (SRI) message.

8. The system of claim 7 wherein the call setup message includes at least one of an integrated services digital network (ISDN) user part (ISUP) initial address message (IAM) and a session initiation protocol (SIP) Invite message.

9. The system of claim 2 wherein the Forward SM message includes an MT_ForwardSM message.

10. The system of claim 3 wherein the query message includes at least one of a sending routing information (SRI) message, an initial detection (IDP) message, and SRI_SM message.

11. The system of claim 1 wherein the signaling node includes at least one of a signal transfer point (STP), a session initiation protocol (SIP) signaling router (SSR), and an application server.

12. The system of claim 1 wherein the parental control module, upon determining not to allow the attempted communication to proceed, establishes a voice path between the calling party device and an interactive voice response (IVR) server.

13. The system of claim 1 wherein the parental control module, upon determining not to allow the communication to proceed, establishes a voice path between the calling party device and the monitoring third party device.

14. The system of claim 1 wherein the parental control module is provisioned with at least one of a white list of permitted call party device numbers and a black list of prohibited call party device numbers.

15. The system of claim 14 wherein the parental control module, upon determining not to allow the communication to proceed, is further configured to add a directory number of the calling party device to the black list.

16. The system of claim 15 wherein the parental control module, upon determining to allow the communication to proceed, is further configured to add a directory number of the calling party device to the white list.

17. A method for third party control of call communications to a monitored called party, the method comprising:
at a signaling node:
receiving a signaling message indicating an attempted call communication to a called party device from a calling party device;
determining if the called party device is subscribed to a call monitoring service;
in response to determining that the called party device is subscribed to the call monitoring service, sending a notification message to a monitoring third party device associated with the called party device, wherein the notification message indicates the attempted call communication between the monitored called party device and the calling party device;
receiving a response to the notification message from the third party device; and
determining whether or not to allow the attempted communication to proceed between the monitored called party device and calling party device based on the response from the monitoring third party device.

18. The method of claim 17 wherein the notification message to the third party device includes at least one of a short message service (SMS) message, an email message, an instant message, and a multimedia message service (MMS) message.

19. The method of claim 17 wherein the response from the third party device includes at least one of a short message service (SMS) message, an email message, an instant message, and a multimedia message service (MMS) message.

20. The method of claim 17 further comprises querying at least one database to obtain information corresponding to a calling party associated with the calling party device.

21. The method of claim 20 wherein the database includes at least one of a calling party name (CNAM) database containing calling party identification information corresponding to a calling party associated with the calling party device, a sex offender database containing sex offender status information corresponding to a calling party associated with the calling party device, a subscriber blacklist, and a subscriber white list.

22. The method of claim 20 wherein the notification message includes the information obtained from the at least one database.

23. The method of claim 17 wherein the signaling message includes at least one of a call setup message, a forward short message (ForwardSM) message, and a send routing information (SRI) message.

24. The method of claim 23 wherein the call setup message includes at least one of an integrated services digital network (ISDN) user part (ISUP) initial address message (IAM) and a session initiation protocol (SIP) Invite message.

25. The method of claim 18 wherein the Forward SM message includes an MT_ForwardSM message.

26. The method of claim 19 wherein the query message includes at least one of a sending routing information (SRI) message, an initial detection (IDP) message, and SRI_SM message.

27. The method of claim 17 wherein the signaling node includes at least one of a signal transfer point (STP), a session initiation protocol (SIP) signaling router (SSR), and an application server.

28. The method of claim 17 further comprising, upon determining not to allow the attempted communication to proceed, establishing a voice path between the calling party device and an interactive voice response (IVR) server.

29. The method of claim 17 further comprising, upon determining not to allow the communication to proceed, establishing a voice path between the calling party device and the monitoring third party device.

30. The method of claim 17 further comprising provisioning in the signaling node at least one of a white list of permitted call party device numbers and a black list of prohibited call party device numbers.

31. The method of claim 30 further comprising, upon determining not to allow the communication to proceed, adding a directory number of the calling party device to the black list.

32. The method of claim 30 further comprising, upon determining to allow the communication to proceed, adding a directory number of the calling party device to the white list.

33. A system for third party control of call communications to a monitored calling party, the system comprising:
a signaling node for receiving a signaling message indicating an attempted call communication from a calling party device to a called party device; and
a parental control module in the signaling node for:
determining if the calling party device is subscribed to a call monitoring service, for sending a notification message to a monitoring third party device associated with the calling party device in response to determining the calling party device is subscribed to the call monitoring service, wherein the notification message indicates the attempted call communication between the calling party device and the called party device;
receiving a response to the notification message from the third party device; and
determining whether or not to allow the attempted call communication to proceed between the monitored calling party device and called party device based on the response from the monitoring third party device.

34. A method for third party control of call communications to a monitored calling party, the method comprising:
at a signaling node:
receiving a signaling message indicating an attempted call communication from a calling party device to a called party device;
determining if the calling party device is subscribed to a call monitoring service;
in response to determining that the calling party device is subscribed to the call monitoring service, sending a notification message to a monitoring third party device associated with the calling party device, wherein the notification message indicates the attempted call communication between the monitored calling party device and the called party device;
receiving a response to the notification message from the third party device; and
determining whether or not to allow the attempted communication to proceed between the monitored calling party device and called party device based on the response from the monitoring third party device.

35. A computer readable medium having stored thereon computer executable instructions that when executed by a processor of a computer control the computer to perform steps comprising:
receiving a signaling message indicating an attempted call communication to a called party device from a calling party device;
determining if the called party device is subscribed to a call monitoring service;
in response to determining that the called party device is subscribed to the call monitoring service, sending a notification message to a monitoring third party device associated with the called party device, wherein the notification message indicates the attempted call communication between the monitored called party device and the calling party device;
receiving a response to the notification message from the third party device; and
determining whether or not to allow the attempted communication to proceed between the monitored called party device and calling party device based on the response from the monitoring third party device

36. A computer readable medium having stored thereon computer executable instructions that when executed by a processor of a computer control the computer to perform steps comprising:
receiving a signaling message indicating an attempted call communication from a calling party device to a called party device;
determining if the calling party device is subscribed to a call monitoring service;
in response to determining that the calling party device is subscribed to the call monitoring service, sending a notification message to a monitoring third party device associated with the calling party device, wherein the notification message indicates the attempted call communication between the monitored calling party device and the called party device;
receiving a response to the notification message from the third party device; and
determining whether or not to allow the attempted communication to proceed between the monitored calling party device and called party device based on the response from the monitoring third party device.
